(19) United States
(12) Patent Application Publication
(10) Pub. No.: US 2010/0186575 A1
(43) Pub. Date: Jul. 29, 2010

(54) Methods, systems, products, language and processes to depict music

(76) Inventor: Erik M. Rosen, Rock Hill, NY (US)

Correspondence Address: Erik M. Rosen, 279 Lake Louise Marie Road, PO Box 525, Rock Hill, NY, 12775, US

(21) Appl. No.: 12/657,270

(22) Filed: Jan. 19, 2010

Related U.S. Application Data
(60) Provisional application No. 61/205,916, filed on Jan. 26, 2009.

(51) Int. Cl. G09B 15/00

(52) U.S. Cl. 84/483.1

(57) ABSTRACT

Methods, systems, products, language and processes are disclosed for the visual depiction of music. The present invention assigns a set of variables for musical note pitch and another set of variables for note duration. A visual depiction of the music is created when the assigned variables are manually and/or automatically translated from musical source materials. Music may be able to be played from the visual image, or output. The image may be converted back to the source material via the Present Invention.

### CROSS-REFERENCE TO RELATED APPLICATIONS

This application claims the benefit of Provisional Patent Application No. 61/205,916, Filing or 371(c) Date Jan. 26, 2009, Titled “Art/Music Depiction Method, Device, Conversion Process and Language” and is incorporated herein in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The Present Invention is a new and novel method/system/product/language/process used for writing, reading, teaching, science, legal and the artistic presentation of music.

Sheet music is the traditional method for writing, reading and teaching music. The location of a note on a five-line scale determines a note's pitch in sheet music. (See FIG. 1.) The shape of the note determines the note's duration. Full notes, half notes, quarter notes, etc. are different shapes. (See FIG. 2.)

Sheet music is neither an intuitive nor an expressive means for displaying music in visual form. The Present Invention makes music easier to write, read, educate and depict. There are no notes to learn or scales to decipher. The Present Invention is an intuitive and expressive means for displaying music in visual form. Indeed, the Present Invention makes music aesthetically pleasing to the eye. The Present Invention can be an artistic means of visualizing and presenting music. (See FIGS. 4 and 5.)

Moreover, the Present Invention is a means or method/system/product/language/process for the conversion of music from any source material into the present language—and visa versa. In other words, the Present Invention includes the conversion of the source material into a visual musical depiction AND the conversion of the visual musical depiction back into the source material. Generally speaking, the Present Invention is the translation or conversion process and ensuing depiction of music, which is displayed in a static format using any combination of shapes, sizes, colors materials, objects, etc. other than traditional sheet music. This language is ideally suited for the visual presentation of music for artistic, educational, scientific, legal or commercial purposes.

### BRIEF SUMMARY OF THE INVENTION

The Present Invention is a new and novel visual musical language. This musical language visually depicts the various musical notes via internally consistent shapes, pictures, sizes, colors, materials, objects, etc. This musical language is ideal for reading, writing and teaching music. This language is also ideally suited for the visual presentation of music for artistic, educational, scientific, entertainment or commercial purposes. The Present Invention also includes all manual, automated or computerized methods—or any combination thereof—for converting, interpreting or displaying music from any audible (e.g. a performance or recording) or written (e.g. sheet music) source material into a visual depiction discussed herein. For instance, one can create an image from traditional sheet music via the Present Invention discussed herein. (See FIGS. 4 and 5.)

This can be a manual process, whereby the resulting depiction or output is manually created via human artistry and skill. It can also be an automatic process, whereby the resulting output or depiction is created without human intervention, e.g. via a machine and/or a computer process. In another format, the musical image is stored in computer memory and a processor communicates with the memory. In yet another embodiment, a computer program product manages the musical language via a computer code. Finally, it can be any combination of manual, automatic and computer processes. Other systems, methods and/or computer program products according to the exemplary embodiments will be or become apparent to one with ordinary skill in the art upon review of the following drawings and Detailed Description. It is intended that all such additional systems, methods, and/or computer program products be included within this description, be within the scope of the claims and be protected by the accompanying claims.

Generally speaking, the Present Invention is the translation process and ensuing depiction or interpretation of musical notes, which is displayed in a static format using any combination of shapes, sizes, colors, materials, objects, etc., but does not include notes, rests, etc. characteristic of traditional sheet music.

### BRIEF DESCRIPTION OF THE SEVERAL VIEWS OF THE DRAWINGS

These and other features, aspects and advantages of the exemplary embodiments are better understood when the Detailed Description is read in conjunction with the following drawings:

FIG. 1 is a depiction of how traditional sheet music articulates pitch, wherein the musical notes are displayed on two five-line scales across the two main clefs;

FIG. 2 is a depiction of how traditional sheet music articulates note duration and rests;

FIG. 3 is a Color Table used to articulate the musical notes in one form of the Present Invention;

FIG. 4 is the song, “Positively Fourth Street,” by Bob Dylan depicted by one form of the Present Invention;

FIG. 5 is the song, “Hey Jude,” by John Lennon and Paul McCartney depicted by one form of the Present Invention;

FIG. 6 is a Shape Table whereby each shape represents a musical note;

FIG. 7 is a sample song employing the Shape Table of FIG. 6;

FIG. 8 is a Shape Table whereby each shape represents note duration;

FIG. 9 is a table whereby letters of the alphabet represent musical notes;

FIG. 10 is a table whereby pictures of drinks represent musical notes;

FIG. 11 is a combination table that combines FIGS. 6, 9 and 10, wherein the Letters of the Alphabet represent their respective musical notes, various shapes represent sharp notes and pictures of drinks represent flat notes;

FIG. 12 is a table whereby different colors represent different note durations, from a Full Note to a Sixty-Fourth Note;

FIG. 13 is a sample song in another form of the Present Invention that employs the tables of FIGS. 11 and 12. The overall visual musical presentation, which is representative of the Present Invention, is in the shape of a house;

FIG. 14 is a flowchart illustrating a method/system/product/language/process for creating and interpreting music via the Present Invention.

### DETAILED DESCRIPTION OF THE INVENTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover all statements herein reciting embodiments, as well as specific examples thereof, are intended to encompass both structural and functional equivalents thereof. Additionally, it is intended that such equivalents include both currently known equivalents and equivalents developed in the future, including any elements developed that perform the same function, regardless of structure.

Thus, it will be appreciated by those of ordinary skill in the art that the diagrams, schematics, illustrations and the like represent conceptual views or processes illustrating the exemplary embodiments. The functions of the various elements shown in the figures may be provided through the use of dedicated hardware and hardware capable of executing associated software or printed materials. Those of ordinary skill in the art further understand that exemplary manual skill, hardware, software, processes, methods and/or operating systems described herein are for illustrative purposes and, thus, are not intended to be limited to any particular system or manufacturer.

In broad terms, a musical note is composed of two variables: Pitch and Duration. In sheet music, Pitch is articulated by the note's location on the five-line scale. FIG. 1 is a depiction of traditional sheet music basics. The seven musical notes (A,B,C,D,E,F.G) are displayed on the five line scales across the two main clefs, treble (top) and bass (bottom).

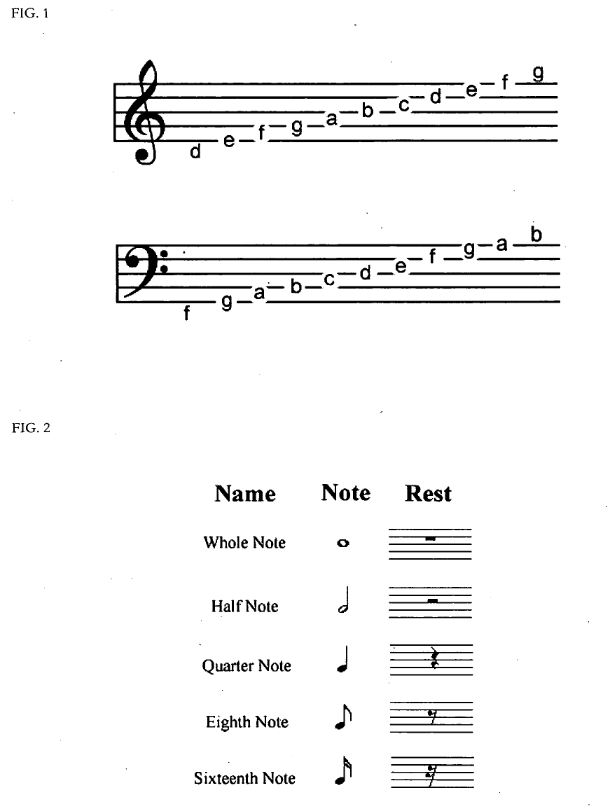

Traditional sheet music depicts note duration by the type or shape of a note on the scale. FIG. 2 depicts the various names and shapes of sheet music Notes and corresponding Rests. A Full Note has twice the duration of a Half Note, which has twice the duration of a Quarter Note, which has twice the duration of an Eighth Note, which has twice the duration of a Sixteenth Note, etc.

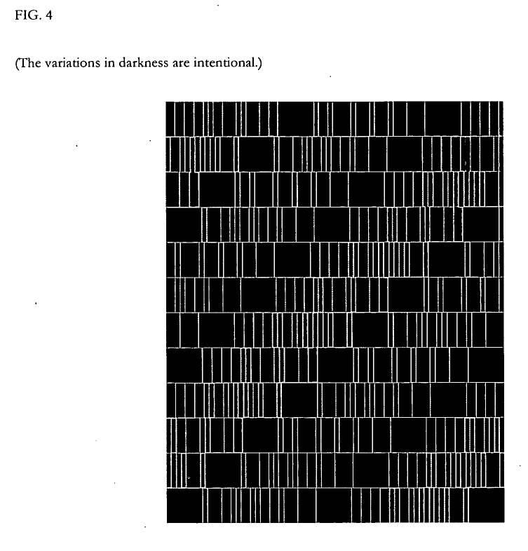

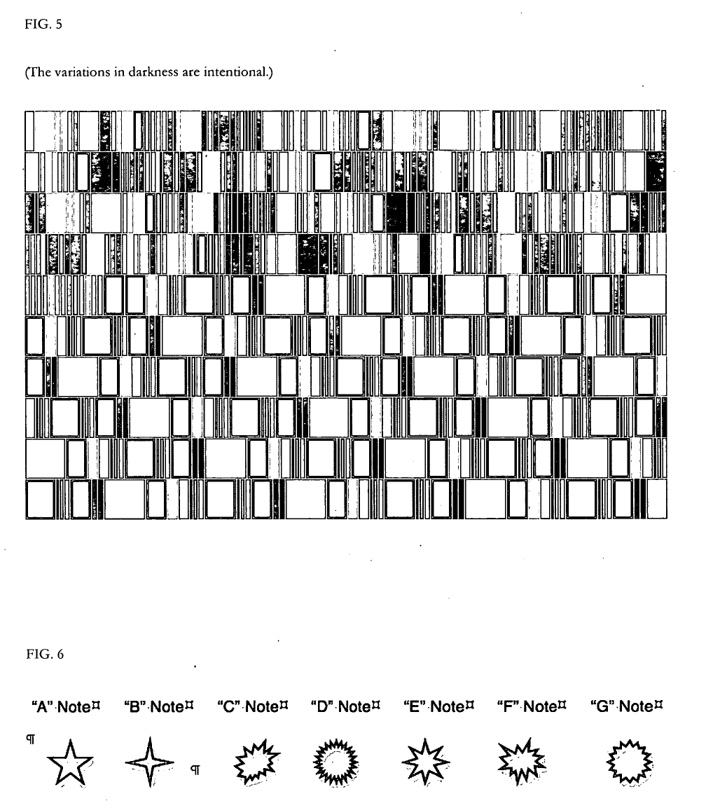

In the Present Invention, there are no five line scales or note shapes to memorize. Music is presented in a clear, intuitive and artistic manner. As described above, the Present Invention is a broad visual language for the articulation of music. Two examples of the Present Invention are attached as FIGS. 4 and 5. They employ a series of rectangles that depict two different songs. For our purposes, this shall be called the “Rectangle Method.” It is only one means of articulating the Present Invention.

Sheet music is one example of musical source material. Other examples of musical source materials include, but are not limited to, recordings or live performances.

### Rectangle Method Example

FIG. 4 is a Bob Dylan song depicted via the Rectangle Method. FIG. 5 is a Lennon/McCartney (Beatles) song depicted by the Rectangle Method of the Present Invention. Although the same method and assumptions were used in these two examples, please note the strikingly different outputs.

The notes of these songs are displayed in chronological order, similar to reading a book. One begins at the top left and finishes at the bottom right. The notes of the song are depicted by rectangles of various colors and widths.

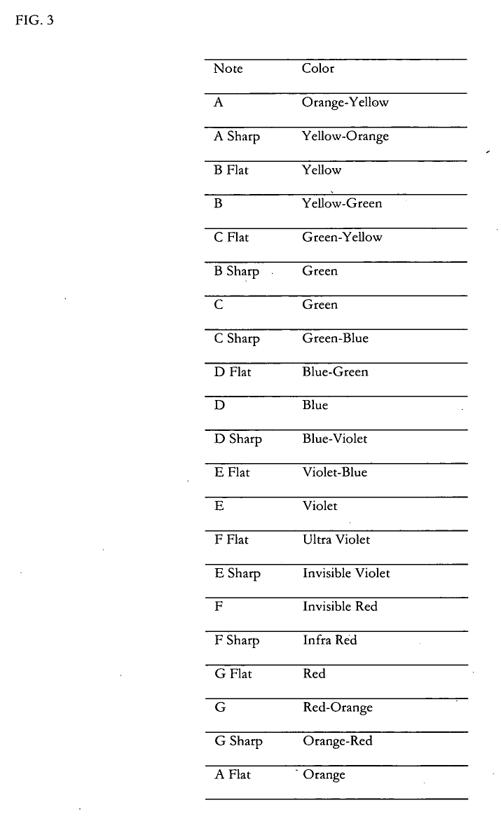

Here, color depicts musical note pitch. In other words, a specific color represents a specific note's pitch. All of the “D” notes in FIGS. 4 and 5 are depicted by the color Blue; all of the “C” notes by the color Green; all of the “A Flat” notes by the color Orange, etc. FIG. 3 is the Color Table used for note pitch in this example. This Color Table is just one set of assumptions that could be used to exemplify the Present Invention. In general, any color could be used to represent any pitch.

Rectangle width represents musical note duration. For instance, a rectangle that is half as wide as another rectangle has a duration that is half as long. A good example of this can be found in FIG. 5. The first two rectangles in the top left-hand corner of FIG. 5 represent a quarter note and a half note, respectively. Logically, the first rectangle is half as wide as the second rectangle because the duration of the first note is half as long as the second note. Thus, note duration in the Rectangle Method of the Present Invention is represented by the relative width of each rectangle.

### The Present Invention is not Limited to the Rectangle Method

The Present Invention is a new and novel visual musical language. This musical language visually depicts music via shapes, pictures, sizes, colors, materials, objects, etc. The output could be temporary or permanent and two-dimensional or three. Music can be transposed from any output back into any source material through the Present Invention. This musical language is ideal for reading, writing and teaching music. This language is also ideally suited for the visual presentation of music for artistic, educational, scientific, legal or commercial purposes. The Present Invention also includes manual, automated and/or computerized methods for converting music from an audible (e.g. recording/performance) or written (e.g. sheet music) source materials into the musical language discussed herein. Generally speaking, the Present Invention is the conversion process and ensuing depiction or interpretation of music that is displayed in a static format other than traditional sheet music.

The Rectangle Method is a simplified means of demonstrating the Present Invention. In the Rectangle Method, color is used to depict note pitch. Any color can be used to represent any note. For instance, a “D” note need not be Blue and an “A Flat” note need not be Orange. Any note can be any color, provided that each note is depicted by the same color throughout the musical piece. For example, one could change all of the “D” notes to Red and all of the “A Flat” notes to Yellow. This would still be considered part of the invention. It is not the colors, themselves, that are the subject of the Present Invention. The combination of colors is unlimited.

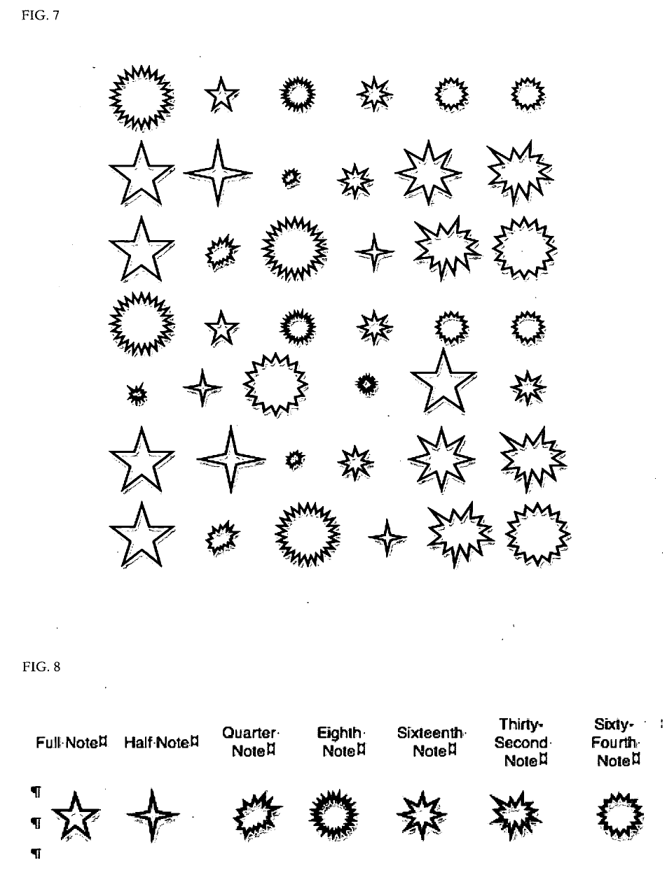

Moreover, musical notes need not even be depicted by color. A note can be depicted by any object, shape, material, picture, etc. or combination thereof. For example, one could depict the Present Invention as a series of shapes. FIG. 6 is a Shape Table that represents the musical notes. FIG. 7 employs the Shape Table to create a sample song (“Shape Method”).

The Shape Method song depiction of FIG. 7 is similar to the Rectangle Method Song depictions in FIGS. 4 and 5. For instance, shape size signifies note duration. In all of these examples, the larger the shape/note, the longer the note duration. However, the Rectangle Method depends on width to signify note duration while the Shape Method depends on the shape's overall size.

Nonetheless, size need not be the determinative factor of note duration in the Present Invention. For example, FIG. 8 is a table that assigns the shape of the note to duration, not pitch. Instead, let's assume in this example that note pitch is determined by note size. Specifically, A notes are the largest size and G notes are the smallest size. Now, when one refers back to FIG. 7, one reads a completely different song. Pitch is determined by size; duration is determined by shape. There are an infinite number of permutations available to depict music in the Present Invention. A few examples of the many possible incarnations include:

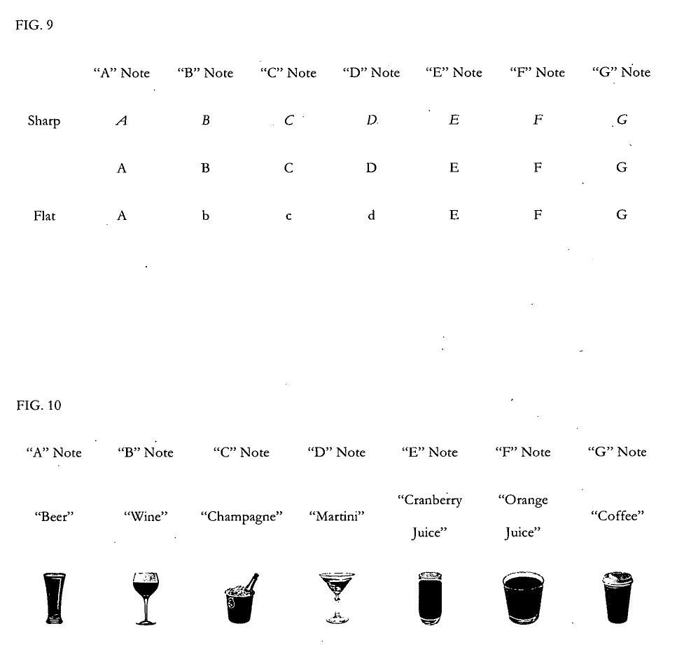

FIG. 9 is a table that uses letters of the alphabet to represent musical notes. Letters “A” through “G” represent notes “A” through “G.” For presentation purposes, let's assume that relative size is the assigned variable for note duration. A larger letter has a longer note duration. Thus, when one sees the letter “A” in a specific size, one sings/plays the note A for a specific duration.

FIG. 10 is a table that employs pictures of drinks to represent musical notes. Here, Notes A, B, C, D, E, F and G are respectively depicted by the following drinks: “Beer,” “Wine,” “Champagne,” “Martini,” “Cranberry Juice,” “Orange Juice” and “Coffee.” This may be a particularly useful table if the song's lyrics pertain to drinking. Again, let's assume that relative size is the assigned variable for note duration. Thus, when one sees a mug of beer in a specific size, one sings/plays the note A for a specific duration.

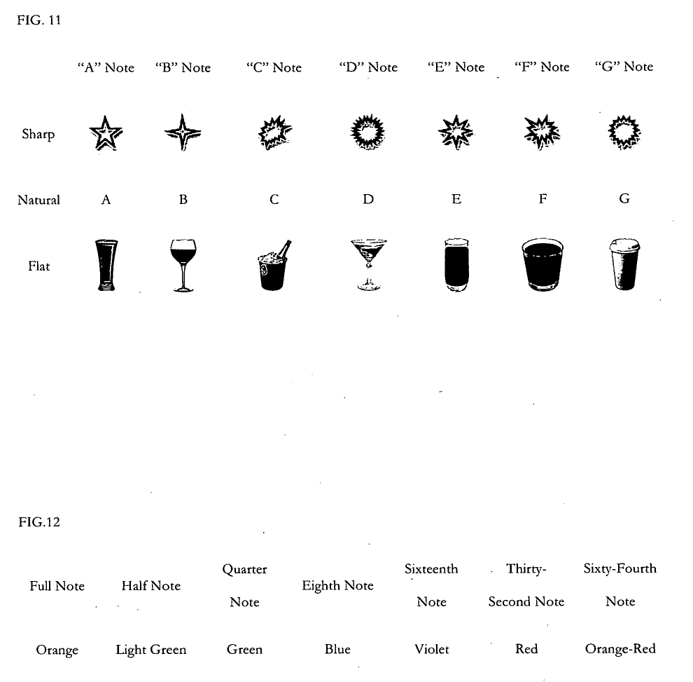

FIG. 11 is a combination table that incorporates FIGS. 6, 9 and 10. In this table, the Letters of the Alphabet represent their respective musical notes. Various shapes represent the sharp notes. Drinks represent the flat notes. One can use the assumptions contained in this table to convert musical source material into a visual output as described herein and visa versa.

FIG. 12 is a table that uses different colors to represent different note durations. For example, the color Green represents a Quarter Note and the color Blue represents an Eighth Note. This is diametrically opposed to the Rectangle Method, but is still representative of the Present Invention. In the Rectangle Method, color depicts note pitch. Here, color depicts note duration.

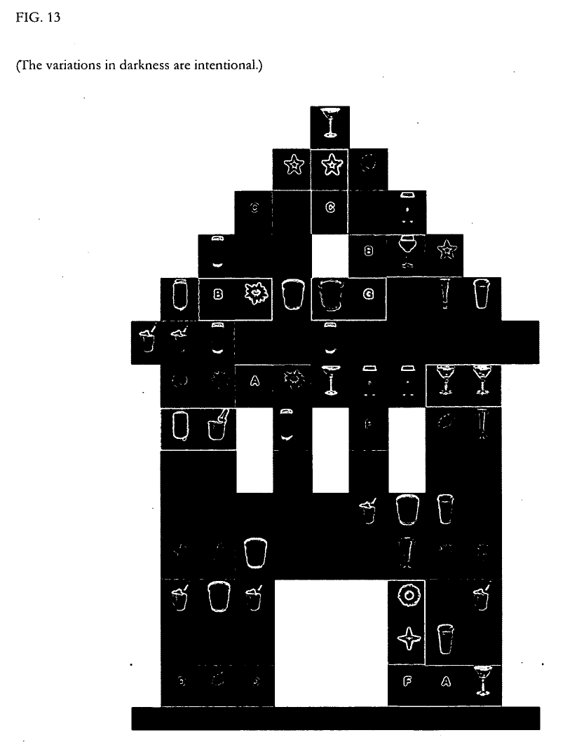

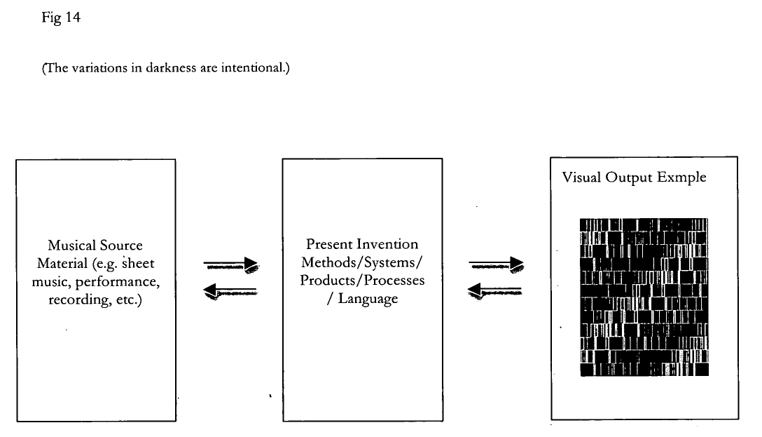

FIG. 13 is a sample song that incorporates the tables of FIGS. 11 and 12. Similar to the Rectangle Method, one reads the notes from left to right like a book. Moreover, in this sample song, shapes, letters and pictures depict pitch, as outlined in FIG. 11. Note duration is depicted by the respective colors of FIG. 12. Please note that the sample song has the overall shape of a house. This could be any shape. It could be in two dimensions or three. Thus, the Present Invention is much more expressive, intuitive and aesthetically appealing compared to traditional sheet music.

Also, in the present invention, the notes could be depicted in any direction: from right to left, top to bottom, bottom to top, diagonally, etc. One need only know the conversion assumptions to interpret the music. The possible permutations for note pitch and duration are unlimited. Notes could be in two dimensions or three. One could use any material or object. For instance, actual Martinis, Bottles of Champagne or Cups of Coffee could represent the musical notes.

Similarly, there are an infinite number of overall shapes one could use to depict music via the Present Invention. Instead of a house in FIG. 13, the overall shape of a song could be a boat or a piece of furniture. The overall song shape could be in two dimensions or three. For example, one could depict a song as a piece of furniture that someone could actually sit on.

The Present Invention also includes all manual, automated and computerized methods for transposing, converting, and/or interpreting music from an audible (e.g. recordings or performances) or written (e.g. sheet music) source material into the musical language discussed herein. In other words, the Present Invention incorporates the all processes for translating, transposing or converting music into the visual musical language discussed herein. It includes all methods, whether they are automatic, computerized, manual or any combination thereof. Finally, the Present Invention includes the output of the conversion process, whether that is a permanent depiction (e.g. ink, paint, printed materials, textiles, objects, composites, etc.) or a temporary depiction (e.g. pencil, chalk, video screen, etc.). The Present Invention includes any output or medium capable of communicating the musical language discussed herein. Finally, the Present Invention inherently includes any process that is capable of transposing the output into musical any source materials.

What is claimed is:

1. A method for depicting music, comprising the following steps:
acquiring musical source material;
assigning a variable for musical note pitch;
assigning a variable for musical note duration;
converting the musical source material according to the assigned variables for musical note pitch and duration;
production of an output that is a visual representation of the music.

2. A method according to claim 1, wherein the visual output may be converted back into a source material.

3. A method according to claim 1, wherein the conversion is manually performed via human skill.

4. A method according to claim 1, wherein the conversion is automatically performed by a machine or the use of computer technology.

5. A method according to claim 1, wherein the conversion is performed via a combination of manual and automatic methods.

6. A method according to claim 1, wherein the output is permanent.

7. A method according to claim 1, wherein the output is temporary.

8. A system, comprising:
acquiring musical source material;
assigning a variable for musical note pitch;
assigning a variable for musical note duration;
converting the musical source material according to the assigned variables for musical note pitch and duration;
production of an output that is a visual representation of the music.

9. A system according to claim 8, wherein the visual output may be converted back into a source material.

10. A system according to claim 8, wherein the conversion is manually performed via human skill.

11. A system according to claim 8, wherein the conversion process is automatically performed by a machine or the use of computer technology.

12. A system according to claim 8, wherein the conversion is performed via a combination of manual skill and automatic technology.

13. A system according to claim 8, wherein the output is permanent.

14. A system according to claim 8, wherein the output is temporary.

15. A translation process, or language, comprising:
acquiring musical source material;
assigning a variable for musical note pitch;
assigning a variable for musical note duration;
converting the musical source material according to the assigned variables for musical note pitch and duration;
production of an output that is a visual representation of the music.

16. A process according to claim 15, wherein the visual output may be converted back into a source material.

17. A process according to claim 15, wherein the process is manually performed via human skill.

18. A process according to claim 15, wherein the process is automatically performed by a machine or the use of computer technology.

19. A process according to claim 15, wherein the process is performed via a combination of manual skill and automatic technology.

20. A process according to claim 15, wherein the output is permanent or temporary.
